(19) United States
(12) Patent Application Publication
(10) Pub. No.: US 2025/0233602 A1
(43) Pub. Date: Jul. 17, 2025

(54) METHODS AND APPARATUSES FOR ADAPTING CONFIGURATIONS FOR CONVERTING BETWEEN ANALOG AND DIGITAL SIGNALS

(71) Applicant: Huawei Technologies Co., Ltd., Shenzhen (CN)

(72) Inventors: Hao Tang, Ottawa (CA); Jianglei Ma, Ottawa (CA); Liqing Zhang, Ottawa (CA); Xiaoyan Bi, Shanghai (CN)

(21) Appl. No.: 19/084,204

(22) Filed: Mar. 19, 2025

Related U.S. Application Data
(63) Continuation of application No. PCT/CN2022/121143, filed on Sep. 24, 2022.

(51) Int. Cl. H04B 1/00; H04B 7/06; H04L 1/00

(52) U.S. Cl. CPC H04B 1/0028; H04B 7/0632; H04L 1/0003; H04L 1/0009

(57) ABSTRACT

Aspects of the present disclosure provide methods and apparatuses for adapting configurations for converting between analog and digital signals. An apparatus receives, from a device, information indicative of an operating configuration for converting between analog and digital signals at the apparatus, and operates according to the operating configuration to which the received information is related. The operating configuration is associated with a bit resolution used by the apparatus when converting signals, a sampling rate used by the apparatus, and/or a combination of bit resolution and sampling rate used by the apparatus.

### CROSS-REFERENCE TO RELATED APPLICATION

This application is a continuation of International Application No. PCT/CN2022/121143, titled “METHODS AND APPARATUSES FOR ADAPTING CONFIGURATIONS FOR CONVERTING BETWEEN ANALOG AND DIGITAL SIGNALS,” and filed on Sep. 24, 2022, all the contents of which are hereby incorporated by reference in their entireties.

### TECHNICAL FIELD

The present application relates to wireless communication generally, and, in particular embodiments, to methods and apparatuses for adapting configurations for converting between analog and digital signals.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a TRP may wirelessly transmit information to a UE in a downlink communication over a particular frequency (or range of frequencies) for a particular duration of time. The frequency and time duration are examples of resources, typically referred to as time-frequency resources. Multiple access occurs when more than one UE is scheduled on a set of time-frequency resources. Each UE uses a portion of the time-frequency resources to receive data from the TRP in the case of a downlink communication, or to transmit data to the TRP in the case of an uplink communication.

The UE and the TRP may each use a respective analog-to-digital convertor (ADC) and/or digital-to-analog convertor (DAC). For example, an ADC may be used to convert an analog signal received over a wireless channel into digital bits, and a DAC may be used to convert digital bits into an analog signal for transmission over a wireless channel. Generally speaking, the resolution of an ADC and the resolution of a DAC may be expressed in terms of the number of bits (e.g. N bits) used for converting between analog and digital samples. For simplicity, the ADC and the DAC may be identified as N-bit ADC and N-bit DAC, thereby indicating their respective resolutions.

When the ADC/DAC resolutions are high (i.e. Nis large), the ADC and DAC can produce an output with relatively good accuracy. For example, when Nis high, the ADC may produce the digital output signal with high precision, as there are more bits to use when digitizing the analog input signal. However, there will be large energy consumption for high ADC/DAC resolutions. In fact, energy consumption of ADC/DAC may increase exponentially as ADC/DAC resolution increases.

### SUMMARY

Due to high energy consumption, high ADC/DAC resolutions are not always desired to use. However, low ADC/DAC resolutions are not always desired, either. For example, given that the signal-to-noise ratio (SNR) of an output signal of an N-bit ADC may be calculated as 6.02*N+1.76 dB+10*lg Fs/2BW), where N is the number of bits indicative of the resolution of the ADC, dB is a decibel indicative of difference between two signals in ratio (e.g. difference in the power, voltage, or signal strength between two points in a cable or network), Fs is the sampling rate, and BW is the signal bandwidth, the SNR of the output signal of the N-bit ADC will be low if N is low (i.e. low ADC resolution). Therefore, the low ADC/DAC resolutions would not be desired and would not be acceptable in some cases, due to low signal quality. This indicates that high ADC/DAC resolutions may be desired for high throughput in some cases and low ADC/DAC resolutions may be more desired for power saving in some other cases. Therefore, it will be beneficial to have multiple configurations for ADC/DAC with different ADC/DAC resolutions and support dynamic switching between different ADC/DAC resolutions.

In long term evolution (LTE) and new radio (NR), the resolution of an analog digital converter (ADC) and the resolution of a digital analog converter (DAC) are transparent in protocol, however many aspects of the ADC/DAC resolutions are left for implementation. Under the existing wireless communication protocols, a transmit-and-receive point (TRP; e.g. base station (BS)) does not know the operating configuration for the ADC/DAC resolutions at a user equipment (UE). Put another way, the TRP does not know whether the UE operates using high ADC/DAC resolution or low ADC/DAC resolution. As such, there would be several technical problems when adapting configurations for ADC/DAC or dynamically switching between different ADC/DAC resolutions under the current protocols. For example, if a UE reports a channel quality indicator (CQI) index according to high ADC resolution and changes its operating configuration to use a low ADC resolution after the reporting, there might be decoding failure at the UE because the TRP would use a high modulation and coding scheme (MCS) value based on the assumption that the UE has downlink signal quality better than the actual downlink signal quality at the UE. Based on the report, the TRP would assume the UE uses high ADC resolution. The UE would fail to decode the signal transmitted from the TRP due to the incorrect assumption. On the other hand, if a UE reports a CQI index according to a low ADC resolution but uses a high ADC resolution when decoding a signal on a physical downlink shared channel (PDSCH), the transmission would be inefficient due to a lower MCS value.

Aspects of the present disclosure provide solutions to overcome at least some of the aforementioned problems, for example specific methods and apparatuses for adapting configurations for converting between analog and digital signals.

According to an aspect of the present disclosure, there is provided a method performed by an apparatus, for example but not limited to a user equipment (UE). The method may include receiving, from a device for example but not limited to a TRP (e.g. base station), information indicative of an operating configuration for converting between analog and digital signals at the apparatus. The method may further include operating according to the operating configuration to which the received information is related. The operating configuration may be associated with at least one of: a bit resolution used by the apparatus when converting between analog and digital signals, a sampling rate used by the apparatus, or a combination of bit resolution and sampling rate used by the apparatus.

In some embodiments, the operating configuration may be selected from a plurality of configurations for converting between analog and digital signals at the apparatus, where each configuration is associated with at least one of: a respective bit resolution used by the apparatus when converting between analog and digital signals, a respective sampling rate used by the apparatus, or a respective combination of bit resolution and sampling rate used by the apparatus. In some embodiments, the plurality of configurations may be configured by the device.

In some embodiments, the method may further include transmitting, to the device, information related to channel measurement performed by the apparatus, the information related to the channel measurement being associated with the operating configuration. In some embodiments, the information related to the channel measurement may be further associated with another configuration for converting between analog and digital signals at the apparatus. In some embodiments, the information related to the channel measurement may include information from one or more channel quality indicator (CQI) tables, where the information from the one or more CQI tables includes a CQI value, and each of the one or more CQI tables is associated with at least one configuration for converting between analog and digital signals at the apparatus. In some embodiments, the CQI value may be selected by the apparatus from a CQI table associated with the operating configuration, where the CQI table associated with the operating configuration is one of the one or more CQI tables. In some embodiments, each of the one or more CQI tables may be a respective different table comprising different available modulation orders, different code rates, or both.

In some embodiments, the method may further include receiving, from the device, a modulation and coding scheme (MCS) value associated with a reference configuration for converting between analog and digital signals at the apparatus. In some embodiments, the MCS value may be selected from an MCS table associated with the reference configuration, where the MCS table associated with the reference configuration is one of a plurality of MCS tables, and each of the plurality of MCS tables is associated with at least one configuration for converting between analog and digital signals at the apparatus. In some embodiments, each of the plurality of MCS tables may be a respective different MCS table comprising different available modulation orders, different code rates, or both. In some embodiments, the reference configuration may be the operating configuration. In some embodiments, the reference configuration may differ from the operating configuration. In some embodiments, the reference configuration may be configured by the device.

In some embodiments, the method may further include transmitting, to the device, information related to capability of the apparatus for converting between analog and digital signals.

In some embodiments, the method may further include receiving, from the device, information indicative of a device operating configuration for converting between analog and digital signals at the device. The method may further include operating based on the information indicative of the device operating configuration. The device operating configuration may be associated with at least one of: a device bit resolution used by the device when converting between analog and digital signals, a device sampling rate used by the device, or a device combination of bit resolution and sampling rate used by the device.

In some embodiments, the device operating configuration may be selected from a plurality of device configurations for converting between analog and digital signals at the device, where each device configuration is associated with at least one of: a respective device bit resolution used by the device when converting between analog and digital signals, a respective device sampling rate used by the device, or a respective device combination of bit resolution and sampling rate used by the device. In some embodiments, the plurality of device configurations may be configured by the device.

In some embodiments, the operating may include the apparatus using a channel quality indicator (CQI) or modulation and coding scheme (MCS) table associated with the device operating configuration. In some embodiments, the information indicative of the device operating configuration may be transmitted using broadcast signaling, radio resource control (RRC), medium access control (MAC) control element (MAC-CE), or downlink control information (DCI). In some embodiments, the information indicative of the device operating configuration may include at least one of: an indication of a table of channel quality values associated with the device operating configuration; or an indication of a table of modulation and coding scheme (MCS) values associated with the device operating configuration.

In some embodiments, the method may further include receiving, from the device, information indicative of the operating configuration. The method further includes performing a configuration change including: deactivating a former configuration for converting between analog and digital signals at the apparatus, and activating the operating configuration based on the information indicative of the operating configuration.

In some embodiments, the information indicative of the operating configuration may include an explicit indication of the operating configuration. In some embodiments, the information indicative of the operating configuration may be transmitted using broadcast signaling, radio resource control (RRC), medium access control (MAC) control element (MAC-CE), or downlink control information (DCI). In some embodiments, the information indicative of the operating configuration may include information related to at least one of: power consumption mode of the apparatus, type of the apparatus, scheduled MCS, number of resource blocks, transport block size, number of transport blocks, number of layers for data transmission, or carrier frequency range.

In some embodiments, the method may further include transmitting, to the device, a request for the configuration change. In some embodiments, the request for the configuration change may include at least one of preferred configuration for converting between analog and digital signals at the apparatus, or preferred MCS level of the apparatus. In some embodiments, the request for the configuration change may be transmitted using dedicated scheduling request resource, MAC-CE, physical uplink control channel (PUCCH), or RRC reconfiguration request.

In some embodiments, the apparatus may perform the configuration change after a configuration change delay. In some embodiments, the configuration change delay is determined based on at least one of: capability of the apparatus for converting between analog and digital signals, a bit resolution associated with the former configuration, a bit resolution associated with the operating configuration, a spectrum range, numerology of an active bandwidth part (BWP), a number of transmitting (Tx) antennas, a number of receiving (Rx) antennas, a number of radio frequency (RF) chains, or carrier bandwidth or active BWP bandwidth.

In some embodiments, the operating configuration may be specific to apparatus, carrier or spectrum range, BWP, RF chain, Tx antenna, Tx antenna group, Rx antenna, or Rx antenna group.

According to an aspect of the disclosure there is provided an apparatus including a memory and a processor. The memory is configured to store processor-executable instructions and the processor is configured to execute the processor-executable instructions to cause the apparatus to perform a method consistent with the embodiments described above.

According to another aspect of the present disclosure, there is provided a method performed by a device, for example but not limited to a TRP (e.g. base station). The method may include determining an operating configuration for converting between analog and digital signals at an apparatus, for example but not limited to a user equipment (UE). The method may further include transmitting, to the apparatus, information indicative of the operating configuration. The operating configuration may be associated with at least one of: a bit resolution used by the apparatus when converting between analog and digital signals, a sampling rate used by the apparatus, or a combination of bit resolution and sampling rate used by the apparatus.

In some embodiments, the determining the operating configuration may include selecting the operating configuration from a plurality of configurations for converting between analog and digital signals at the apparatus, where each configuration is associated with at least one of: a respective bit resolution used by the apparatus when converting between analog and digital signals, a respective sampling rate used by the apparatus, or a respective combination of bit resolution and sampling rate used by the apparatus. In some embodiments, the method may further include configuring mappings between each of the plurality of configurations and at least one of the respective bit resolution, the respective sampling rate, or the respective combination of bit resolution and sampling rate.

In some embodiments, the method may further include configuring mappings between each of the plurality of configurations and at least one of the respective bit resolution, the respective sampling rate, or the respective combination of bit resolution and sampling rate.

In some embodiments, the method may further include receiving, from the apparatus, information related to channel measurement performed by the apparatus, the information related to the channel measurement being associated with the operating configuration. The method may further include transmitting control information scheduling a transmission with the apparatus, the control information allocating resources based on the information related to the channel measurement. In some embodiments, the information related to the channel measurement may be further associated with another configuration for converting between analog and digital signals at the apparatus. In some embodiments, the information related to the channel measurement may include information from one or more channel quality indicator (CQI) tables, where the information from the one or more CQI tables includes a CQI value, and each of the one or more CQI tables is associated with at least one configuration for converting between analog and digital signals at the apparatus. In some embodiments, the CQI value may be from a CQI table associated with the operating configuration, where the CQI table associated with the operating configuration is one of the one or more CQI tables. In some embodiments, each of the one or more CQI tables may be a respective different table comprising different available modulation orders, different code rates, or both.

In some embodiments, the method may further include determining a modulation and coding scheme (MCS) value associated with a reference configuration for converting between analog and digital signals at the apparatus based on the information related to the channel measurement for the scheduled transmission with the apparatus. The method may further include transmitting, to the apparatus, the MCS value associated with the reference configuration. In some embodiments, the MCS value may be selected from an MCS table associated with the reference configuration, where the MCS table associated with the reference configuration is one of a plurality of MCS tables, and each of the plurality of MCS tables is associated with at least one configuration for converting between analog and digital signals at the apparatus. In some embodiments, each of the plurality of MCS tables may be a respective different table comprising different available modulation orders, different code rates, or both. In some embodiments, the reference configuration may be the operating configuration. In some embodiments, the reference configuration may differ from the operating configuration. In some embodiments, the reference configuration may be configured by the device.

In some embodiments, the method may further include receiving, from the apparatus, information related to capability of the apparatus for converting between analog and digital signals.

In some embodiments, the method may further include determining a device operating configuration for converting between analog and digital signals at the device, transmitting, to the apparatus, information indicative of the device operating configuration, and operating based on the information indicative of the device operating configuration. The device operating configuration may be associated with at least one of: a device bit resolution used by the device when converting between analog and digital signals, a device sampling rate used by the device, or a device combination of resolution and sampling rate used by the device.

In some embodiments, the determining the device operating configuration includes: selecting the device operating configuration from a plurality of device configurations for converting between analog and digital signals at the device. Each device configuration may be associated with at least one of: a respective device bit resolution used by the device when converting between analog and digital signals, a respective device sampling rate used by the device, or a respective device combination of bit resolution and sampling rate used by the device. In some embodiments, the plurality of device configurations are configured by the device.

In some embodiments, the operating may include the device using a channel quality indicator (CQI) or modulation and coding scheme (MCS) table associated with the device operating configuration. In some embodiments, the information indicative of the device operating configuration may be transmitted using broadcast signaling, radio resource control (RRC), medium access control (MAC) control element (MAC-CE), or downlink control information (DCI). In some embodiments, the information indicative of the device operating configuration may include at least one of: an indication of a table of channel quality values associated with the device operating configuration; or an indication of a table of modulation and coding scheme (MCS) values associated with the device operating configuration.

In some embodiments, the method may further include transmitting, to the apparatus, information indicative of the operating configuration for a configuration change to be performed by the apparatus. The configuration change may include deactivating a former configuration for converting between analog and digital signals at the apparatus, and activating the operating configuration based on the information indicative of the operating configuration. In some embodiments, the information indicative of the operating configuration may include an explicit indication of the operating configuration. In some embodiments, the information indicative of the operating configuration may be transmitted using broadcast signaling, radio resource control (RRC), medium access control (MAC) control element (MAC-CE), or downlink control information (DCI). In some embodiments, the information indicative of the operating configuration may include information related to at least one of: power consumption mode of the apparatus, type of the apparatus, scheduled MCS, number of resource blocks, transport block size, number of transport blocks, number of layers for data transmission, or carrier frequency range.

In some embodiments, the method may further include receiving, from the apparatus, a request for the configuration change. In some embodiments, the request for the configuration change may include at least one of preferred configuration for converting between analog and digital signals at the apparatus, or preferred MCS level of the apparatus. In some embodiments, the request for the configuration change may be transmitted using dedicated scheduling request resource, MAC-CE, physical uplink control channel (PUCCH), or RRC reconfiguration request.

In some embodiments, the apparatus may perform the configuration change after a configuration change delay. In some embodiments, the configuration change delay may be determined based on at least one of: capability of the apparatus for converting between analog and digital signals, a bit resolution associated with the former configuration, a bit resolution associated with the operating configuration, a spectrum range, numerology of an active bandwidth part (BWP), a number of transmitting (Tx) antennas, a number of receiving (Rx) antennas, a number of radio frequency (RF) chains, or carrier bandwidth or active BWP bandwidth.

In some embodiments, the operating configuration may be specific to apparatus, carrier or spectrum range, BWP, RF chain, Tx antenna, Tx antenna group, Rx antenna, or Rx antenna group.

According to an aspect of the disclosure there is provided a device including a memory and a processor. The memory is configured to store processor-executable instructions and the processor is configured to execute the processor-executable instructions to cause the device to perform a method consistent with the embodiments described above.

Technical benefits of some aspects of the present disclosure may be as follows.

By virtue of some aspects of the present disclosure, there may be a plurality of configurations for converting between analog and digital signals at the apparatuses and/or the devices, such as but not limited to UEs and TRPs, and dynamic switching between different configurations may be supported such that low ADC/DAC resolutions are used when power saving is needed and high ADC/DAC resolutions are used when high throughput is needed.

By virtue of some aspects of the present disclosure, capability for converting between analog and digital signals may be actively aligned between apparatuses and devices (e.g. TRP and UE) so that resources can be properly scheduled and allocated by the apparatuses and devices. The capability alignment may also enable dynamic change of configurations for converting between analog and digital signals, thereby saving power of the apparatuses and devices.

As noted above, by virtue of some aspects of the present disclosure, configurations for converting between analog and digital signals (e.g. low ADC/DAC resolution to high ADC/DAC resolution) may be dynamically changed. The configuration change may be performed with a certain delay (e.g. configuration change delay) which may be determined based on one or more factors, for example but not limited to capability of the apparatus for converting between analog and digital signals.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates two devices wirelessly communicating, according to embodiments of the present disclosure;

FIG. 6 illustrates a channel quality indicator (CQI) table derived from a master CQI table, in accordance with embodiments of the present disclosure;

FIG. 7 illustrates a a modulation and coding scheme (MCS) table derived from a master MCS table, in accordance with embodiments of the present disclosure;

FIG. 8 is a flow diagram illustrating an example process for adapting configuration for converting between analog and digital signals at the apparatus, in accordance with embodiments of the present disclosure;

FIG. 9 is a flow diagram illustrating an example process for adapting configuration for converting between analog and digital signals at the device, in accordance with embodiments of the present disclosure; and

FIG. 10 is a flow diagram illustrating an example process for changing configuration for converting between analog and digital signals at the apparatus, in accordance with embodiments of the present disclosure.

### DETAILED DESCRIPTION

In the present disclosure, “analog-to-digital converter (ADC)” refers to a system that converts an analog signal into a digital signal, and a digital-to-analog converter (DAC) refers to a system that converts a digital signal into an analog signal.

In the present disclosure, “ADC resolution” or “resolution of an ADC” is defined as the smallest incremental voltage that can be recognized and thus causes a change in the digital output. The ADC resolution is expressed as the number of bits that can be output by the ADC, and therefore may be called bit resolution. For example, for an n-bit ADC, the number of discrete digital values that can be output by the ADC may be 2ₙ.

In the present disclosure, “DAC resolution” or “resolution of a DAC” is the smallest increment of output that the DAC can produce. The DAC resolution may be determined based on the number of bits (N) and may be calculated as range/2ⁿ, where the range is the full-scale value that can be measured by DAC. The resolution may be referred to as a bit resolution. The DAC bit resolution may be also expressed in the percentage value. For example, for an n-bit DAC, the DAC resolution may be ½ⁿ.

For illustrative purposes, specific example embodiments will now be explained in greater detail below in conjunction with the figures.

### Example Communication Systems and Devices

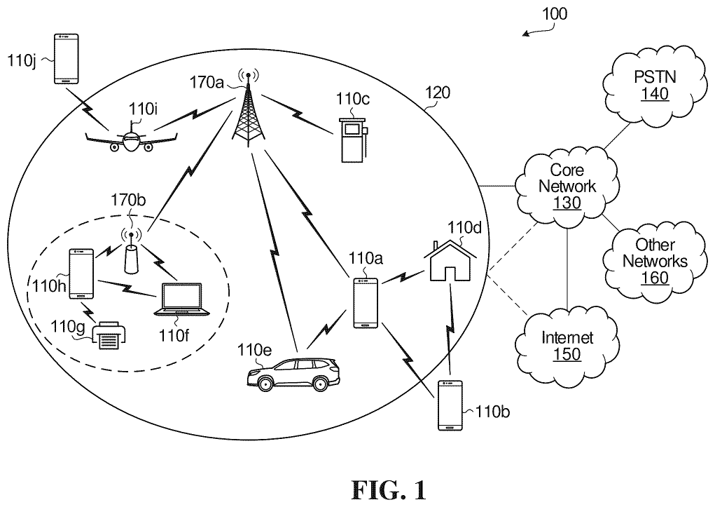

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

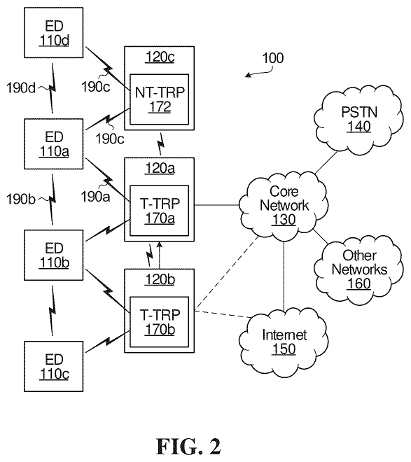

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

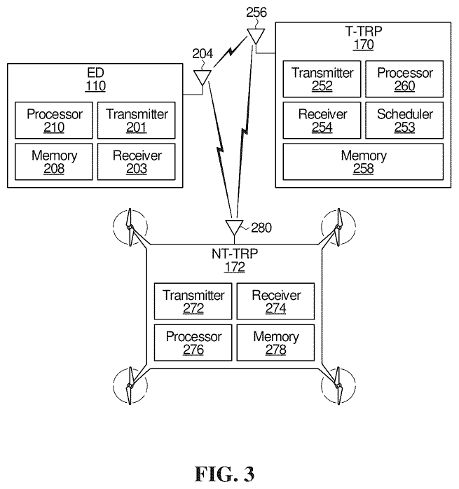

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and may hereafter be referred to as T-TRP 170. Also shown in FIG. 3, a NT-TRP may hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may be alternatively panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, baseband unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

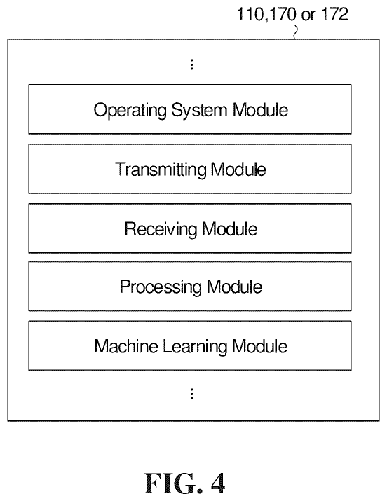

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC control element (CE)). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

Channel measurement is referenced in some embodiments herein. In wireless communication, signals may be transmitted that are used for measurement and feeding back measurement results. As an example, a TRP may transmit to a UE a reference signal or a synchronization signal. An example of a reference signal is a channel state information (CSI) reference signal (CSI-RS). An example of a synchronization signal is a primary synchronization signal (PSS) and/or a secondary synchronization signal (SSS). The reference signal and/or synchronization signal may be used by the UE to perform a measurement and thereby obtain a measurement result. The measurement result may be a channel measurement result, e.g. of channel quality. Examples of possible measurements include: measuring CSI, such as information related to scattering, fading, power decay and/or signal-to-noise ratio (SNR) in the channel; and/or measuring signal-to-interference-plus-noise ratio (SINR), which is sometimes instead called signal-to-noise-plus-interference ratio (SNIR); and/or measuring Reference Signal Receive Power (RSRP); and/or measuring Reference Signal Receive Quality (RSRQ); and/or measuring channel quality, e.g. to obtain a channel quality indicator (CQI). Performing a measurement on a received signal may include extracting waveform parameters from the signal, such as (but not limited to) amplitude, frequency, noise and/or timing of the waveform. The result may be the measurement. The result of the measurement is referred to as the measurement result, e.g. the measurement result may be the measured SNR, SINR, RRSP, and/or RSRQ. A measurement report may then be transmitted from the UE back to the TRP. The measurement report may report some or all of the measurement result. The measurement result may be used by the network to perform link adaptation, radio resource management (RRM), etc. Instead of a measurement report, other content dependent upon the measurement result may be transmitted back to the TRP, e.g. the UE may transmit an indication of a codebook and/or rank indicator for use by the TRP for precoding. In another example, the UE may perform an inter-UE or inter-layer interference measurement, and report information back in a measurement report. In another example, sensing may be performed and sensing results reported.

The feedback does not necessarily need to be an explicit indication of a channel quality, but might instead be content that was selected or derived based on the measurement result, e.g. an indication of an MCS, an indication of a codebook and/or rank indicator for precoding, etc.

Therefore, many different items of information may be fed back in signaling during operation, typically based on measurement of a received signal. For example, information fed back from one device to another may include CSI, CQI, SNR, SINR, RRSP, RSRQ, codebook/rank indicator for precoding, indication of MCS, etc. Any of these may be considered information related to a channel measurement. In some embodiments herein, CQI is provided as an example, but the information related to channel measurement is not limited to CQI.

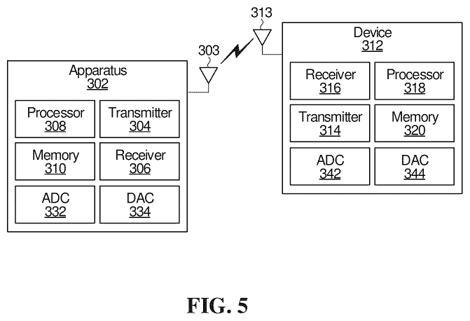

Embodiments are not limited to uplink and/or downlink communication. More generally, two devices may be wirelessly communicating with each other. FIG. 5 illustrates two devices wirelessly communicating, according to embodiments of the present disclosure. To more easily distinguish between the two devices, one will be referred to as apparatus 302 and the other will be referred to as device 312. The apparatus 302 may be a UE. The device 312 may be a network device, e.g. a TRP. However, this is not necessary. For example, the apparatus 302 may be a UE or network device, and the device 312 may be a UE or a network device. The terms “apparatus” 302 and “device” 312 are simply used to more easily distinguish between the two entities. They may be the same type of entity, e.g. the apparatus 302 and the device 312 may both be UEs, or the apparatus 302 and the device 312 may both be network devices (e.g. base stations or other TRPs), although more generally this is not necessary.

In some embodiments, the apparatus 302 is assumed to be one transmitting, to the device 312, information related to channel measurement performed by the apparatus 302. The device 312 is assumed to be the one transmitting the control information scheduling a transmission with the apparatus 302, to the apparatus 302, the control information allocating resources based on the information related to the channel measurement performed by the apparatus 302.

The device 312 includes a transmitter 314 and receiver 316, which may be integrated as a transceiver. The transmitter 314 and receiver 316 are coupled to one or more antennas 313. Only one antenna 313 is illustrated. One, some, or all of the antennas may alternatively be panels. The device 312 further includes a processor 318 for directly performing (or controlling the device 312 to perform) the operations of the device 312 described herein. Although not illustrated, the processor 318 may form part of the transmitter 314 and/or receiver 316. The device 312 further includes a memory 320 for storing information and data. The device 312 further includes an analog-to-digital converter (ADC) 342 and a digital-to-analog converter (DAC) 344 for converting between analog and digital signals. The ADC 342 may be configured to convert an analog input voltage or current to a digital output value (e.g. number) indicative of the magnitude of the input voltage or current. The DAC 344 may be configured to convert a digital input value to an analog output voltage or current. The magnitude of the analog output voltage or current may be proportionate to the digital input value thereby indicating the digital input value.

The processor 318, some or all of the ADC 342 and/or DAC 344, and the processing components of the transmitter 314 and receiver 316 may be implemented by the same or different one or more processors that are configured to execute instructions stored in a memory (e.g. in memory 320). Alternatively, some or all of the processor 318, ADC 342, DAC 344, and/or processing components of the transmitter 314 and/or receiver 316 may be implemented using dedicated circuitry, such as a programmed FPGA, a GPU, or an ASIC. For example, the ADC 342 and DAC 344 may each be implemented by a dedicated integrated circuit (IC) chip, such as a microchip dedicated to performing conversion between analog and digital. The chip may be controlled by a processor, e.g. processor 318.

In some embodiments, the device 312 may be a TRP. If the device 312 is T-TRP 170, then the processor 318 may be or include processor 260 and the processor 318 may implement scheduler 253, the transmitter 314 may be or include transmitter 252, the receiver 316 may be or include receiver 254, and the memory 320 may be or include memory 258. If the device 312 is NT-TRP 172, then the processor 318 may be or include processor 276, the transmitter 314 may be or include transmitter 272, the receiver 316 may be or include receiver 274, and the memory 320 may be or include memory 278.

The apparatus 302 includes a transmitter 304 and a receiver 306, which may be integrated as a transceiver. The transmitter 304 and receiver 306 are coupled to one or more antennas 303. Only one antenna 303 is illustrated. One, some, or all of the antennas may alternatively be panels. The apparatus 302 further includes a processor 308 for directly performing (or controlling the apparatus 302 to perform) the operations of the processor 308 described herein. Although not illustrated, the processor 308 may form part of the transmitter 304 and/or receiver 306. The apparatus 302 further includes a memory 310 for storing information and data. The apparatus 302 further includes an analog-to-digital converter (ADC) 332 and a digital-to-analog converter (DAC) 334 for converting between analog and digital signals. The ADC 332 may be configured to convert an analog input voltage or current to a digital output value (e.g. number) indicative of the magnitude of the input voltage or current. The DAC 334 may be configured to convert a digital input value to an analog output voltage or current. The magnitude of the analog output voltage or current may be proportionate to the digital input value thereby indicating the digital input value.

The processor 308, some or all of the ADC 332 and/or DAC 334, and processing components of the transmitter 304 and/or receiver 306 may be implemented by the same or different one or more processors that are configured to execute instructions stored in a memory (e.g. in memory 310). Alternatively, some or all of the processor 308, ADC 332, DAC 334, and/or processing components of the transmitter 304 and/or receiver 306 may be implemented using dedicated circuitry, such as a programmed FPGA, a GPU, or an ASIC. For example, the ADC 332 and DAC 334 may each be implemented by a dedicated integrated circuit (IC) chip, such as a microchip dedicated to performing conversion between analog and digital. The chip may be controlled by a processor, e.g. processor 308.

If the apparatus 302 is a UE, such as ED 110, then the processor 308 may be or include processor 210, the transmitter 304 may be or include transmitter 201, the receiver 306 may be or include receiver 203, and the memory 310 may be or include memory 208.

The device 312 and the apparatus 302 may include other components, but these have been omitted for the sake of clarity.

Aspects of the present disclosure provide solutions that may overcome the aforementioned problems, for example specific methods and apparatuses for adapting configurations for converting between analog and digital signals. A device, for example but not limited to a transmit-and-receive point (TRP; e.g. base station), may configure one or multiple configurations for converting between analog and digital signals at an apparatus, for example but not limited to a user equipment (UE).

Each configuration may be associated with at least one of a bit resolution used by the apparatus when converting between analog and digital signals, a sampling rate used by the apparatus, or a combination of bit resolution and sampling rate used by the apparatus. Each configuration may be associated with information related to channel measurement performed by the apparatus. For example, each configuration may be associated with a respective channel quality indicator (CQI) table. The apparatus may transmit, to the device, the information related to the channel measurement for example including information from one or more CQI tables associated with one or multiple configurations. Each configuration may be associated with a modulation and coding scheme (MCS) value. The MCS value may be selected from an MCS table associated with a reference configuration for converting between analog and digital signals at the apparatus.

The device may configure mappings between each of the plurality of configurations and at least one of the respective bit resolution, the respective sampling rate, or the respective combination of bit resolution and sampling rate. Some mappings may be pre-defined or pre-configured by the device. The device may select one of the configurations for converting between analog and digital signals at the apparatus and indicate it as an operating configuration.

In some embodiments, the apparatus may operate on the same operating configuration for an analog-to-digital signal conversion and for a digital-to-analog signal conversion. In some embodiments, the apparatus may operate on different operating configurations for converting an analog signal to a digital signal and converting a digital signal to an analog signal. In the present disclosure, expressions such as configurations for converting between analog and digital signals are generally used for simplicity. A person skilled in the art would readily understand that configurations for converting between analog and digital signals may include configurations for an analog-to-digital signal conversion and/or configurations for a digital-to-analog signal conversion. The configurations for an analog-to-digital signal conversion may be same as or different from the configurations for a digital-to-analog signal conversion. The total number of configurations for the analog-to-digital signal conversion may be same as or different from the total number of configurations for the digital-to-analog signal conversion.

The apparatus may perform a configuration change or configuration adaptation explicitly or implicitly. The apparatus may change the configuration on which the apparatus currently operates based on the information indicative of the configuration change. The apparatus may receive the information indicative of the configuration change from the device. The information indicative of the configuration change may be an explicit indication for the apparatus to perform the configuration change. For example, the information may indicate an operating configuration on which the apparatus is to operate, and this may be used as an explicit indication for the apparatus to switch to the new operating configuration. The information indicative of the configuration change may be an implicit indication for the apparatus to perform the configuration change. In such case, the information indicative of the configuration change may include information related to at least one of: power consumption mode of the apparatus, type of the apparatus, scheduled MCS, scheduled resource blocks (e.g. number of resource blocks), scheduled transport block (e.g. transport block size), number of transport blocks, number of layers for data transmission, or carrier frequency range.

The apparatus may perform the configuration change after a configuration change delay. The configuration change delay may be determined based on at least one of: capability of the apparatus for converting between analog and digital signals, a bit resolution associated with the former configuration, a bit resolution associated with the operating configuration, a spectrum range, numerology of an active bandwidth part (BWP), a number of transmitting (Tx) antennas, a number of receiving (Rx) antennas, a number of radio frequency (RF) chains, or carrier bandwidth or active BWP bandwidth.

The configurations for converting between analog and digital signals (e.g. operating configuration) may be specific to apparatus, carrier or spectrum range, BWP, RF chain, Tx antenna, Tx antenna group, Rx antenna, or Rx antenna group.

The device (e.g. TRP) may configure one or multiple device configurations for converting between analog and digital signals at the device. Each device configuration may be associated with at least one of: a bit resolution used by the device when converting between analog and digital signals, a sampling rate used by the device, or a combination of bit resolution and sampling rate used by the device. Some technical features related to the device configurations may be similar to those related to the configurations for converting between analog and digital signals at the apparatus.

According to some embodiments, there are one or multiple configurations for converting between analog and digital signals at the apparatus (e.g. UE). The apparatus may operate (e.g. perform channel measurement, report channel measurement feedback, decode, encode) and convert analog and digital signals based on one of the configurations. The configuration on which the apparatus currently operates may be referred to as operating configuration (for converting between analog and digital signals at the apparatus).

As noted above, the resolution of an analog digital converter (ADC) and the resolution of a digital analog converter (DAC) may be expressed in terms of the number of bits (e.g. N bits) used for converting between analog and digital samples. Each configuration for converting between analog and digital signals may be associated with a respective bit resolution (e.g. N bits) used by the apparatus when converting between analog and digital signals, a respective sampling rate (e.g. Fs) used by the apparatus, and/or a respective combination of bit resolution and sampling rate used by the apparatus. As such, different configurations may have different bit resolutions, different sampling rates, and/or different combinations of bit resolutions and sampling rates.

A device (e.g. TRP) may configure the one or multiple configurations for converting between analog and digital signals at the apparatus, as illustrated below or elsewhere in the present disclosure.

An apparatus (e.g. UE) may report its capability related to analog-digital signal conversion. For example, the apparatus may transmit to the device information related to its capability for converting between analog and digital signals. The information related to capability of the apparatus for converting between analog and digital signals may include at least one of:
bit resolutions supported by the apparatus when converting between analog and digital signals (e.g. a list of N values: {N₁, N₂, N₃, . . . , Nₖ});
sampling rates supported by the apparatus for converting between analog and digital signals (e.g. a list of Fs values: {Fs₁, Fs₂, Fs₃, . . . , Fsₖ}); and
combinations of bit resolutions and sampling rates supported by the apparatus for converting between analog and digital signals (e.g. a list of (N, Fs) values: {(N₁, Fs₁), (N₂, Fs₂), (N₃, Fs₃), . . . , (Nₖ, Fs_{K})}).

After receiving the report/information related to capability of the apparatus for converting between analog and digital signals, the device may configure one or a plurality of configurations for converting between analog and digital signals at the apparatus. In some embodiments, the device may directly configure the respective number of bit resolution (i.e. N) and/or respective sampling rate (i.e. Fs) for converting between analog and digital signals at the apparatus. In other words, the device may directly configure the value of N and/or Fs for some or all of the plurality of configurations. In some embodiments, the device may configure mappings between the configurations and at least one of: the respective bit resolution, the respective sampling rate, or the respective combination of bit resolution and sampling rate. The device may configure indices for the configurations for converting between analog and digital signals at the apparatus. For example, two different configurations may be configured for converting between analog and digital signals at the apparatus. One configuration may be configured for low-resolution (or low bit resolution), and the other configuration may be configured for high-resolution (or high bit resolution). For the low bit resolution, the apparatus uses a smaller number of bits (e.g. N is smaller), lower sampling rates (e.g. Fs value is low), and/or smaller output value of the function f(N, Fs) (e.g. f(N, Fs)=6.02*N+1.76 dB+10*lg(Fs/2BW)) for converting between analog and digital signals, where Nis the number of bits indicative of the ADC/DAC resolution, dB is a decibel indicative of difference between two signals in ratio (e.g. difference in the power, voltage, or signal strength between two points in a cable or network), Fs is the sampling rate, and BW is the signal bandwidth. For the high bit resolution, the apparatus uses a larger number of bits (e.g. N is larger), higher sampling rates (e.g. Fs value is high), and/or greater output value of the function f(N, Fs).

One of the plurality of configurations may be configured by the device as an operating configuration which is the configuration on which the apparatus would operate. For example, the device may select one of the configurations for converting between analog and digital signals at the apparatus and indicate as an operating configuration.

In some embodiments, some mappings between the configurations and at least one of: the respective bit resolution, the respective sampling rate, or the respective combination of bit resolution and sampling rate may be pre-defined or pre-configured by the device. Some examples of such pre-configured mappings are provided below in Table 1, Table 2, and Table 3.

TABLE 1
Mapping between configurations and bit resolutions (N-bit)

| Configurations for analog- | |
|---|---|
| digital signal conversion | Bit resolutions (N-bit) |
| Configuration 1 | 1 |
| Configuration 2 | 4 |
| Configuration 3 | 8 |
| Configuration 4 | 16 |

TABLE 2
Mapping between configurations and sampling rates (Fs)

| Configurations for analog- | |
|---|---|
| digital signal conversion | Sampling rate (Fs) |
| Configuration 1 | fo |
| Configuration 2 | 2*fo |
| Configuration 3 | 4*fo |
| Configuration 4 | 8*fo |

TABLE 3
Mapping between configurations and (N, Fs)

| Configurations for analog- | |
|---|---|
| digital signal conversion | (N, Fs) |
| Configuration 1 | (1, fo) |
| Configuration 2 | (4, 2*fo) |
| Configuration 3 | (4, 4*fo) |
| Configuration 4 | (8, 8*fo) |

In some embodiments, each configuration for converting between analog and digital signals may be associated with information related to the channel measurement performed by the apparatus. The information related to the channel measurement may include information from one or more channel quality indicator (CQI) tables. Each CQI table may be associated with at least one configuration for converting between analog and digital signals at the apparatus. Put another way, multiple configurations for converting between analog and digital signals at the apparatus may be associated with the same CQI table. Mapping between the configurations and the CQI table(s) may be pre-defined or pre-configured for example by the device (e.g. TRP).

Two example CQI tables are provided below in Table 4 and Table 5A. Table 4 illustrates an example CQI table associated with a configuration for a high bit resolution, and Table 5A illustrates an example CQI table associated with a configuration for a low bit resolution.

TABLE 4
CQI table associated with configuration for high bit resolution

| | | | |
|---|---|---|---|
| CQI index | Modulation | Code rate × 1024 | efficiency |

| | |
|---|---|
| 0 | Out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 5A
CQI table associated with configuration for low bit resolution

| | | | |
|---|---|---|---|
| CQI index | Modulation | Code rate × 1024 | efficiency |

| | |
|---|---|
| 0 | Out of range |

| | | | |
|---|---|---|---|
| 1 | BPSK | 25 | 0.0244 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |

A CQI table may be generated based on another CQI table. For example, the above Table 5A may be generated based on the above Table 4. Specifically, one or multiple entries may be added to Table 4 at lower efficiency side (e.g. added entries at CQI index=1, 2 in Table 5A), and one or more entries are removed from Table 4 at higher side (e.g. 64 QAM (Quadrature Amplitude Modulation) entries, entries at CQI index=10-15 in Table 4), as shown above. Table 5B below illustrates the difference between Table 4 and Table 5A, thereby showing how Table 5A is generated based on Table 4. In Table 5B below, the double-brackets and strikethroughs indicate the deleted or cancelled values, and the underlines indicate the added or updated values.

TABLE 5B
CQI table associated with configuration for low bit resolution

| | | | |
|---|---|---|---|
| CQI | | | |
| index | Modulation | Code rate × 1024 | efficiency |

| | |
|---|---|
| 0 | Out of range |

| | | | |
|---|---|---|---|
| 1 | BPSK | 25 | 0.0244 |
| 2 | QPSK | 50 | 0.0977 |
| [[1]] 3 | QPSK | 78 | 0.1523 |
| [[2]] 4 | QPSK | 120 | 0.2344 |
| [[3]] 5 | QPSK | 193 | 0.3770 |
| [[4]] 6 | QPSK | 308 | 0.6016 |
| [[5]] 7 | QPSK | 449 | 0.8770 |
| [[6]] 8 | QPSK | 602 | 1.1758 |
| [[7]] 9 | 16QAM | 378 | 1.4766 |
| [[8]] 10 | 16QAM | 490 | 1.9141 |
| [[9]] 11 | 16QAM | 616 | 2.4063 |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |

Each CQI table may be a respective different table comprising different available modulation orders, different code rates, or both, for example as shown above in Tables 4 and 5.

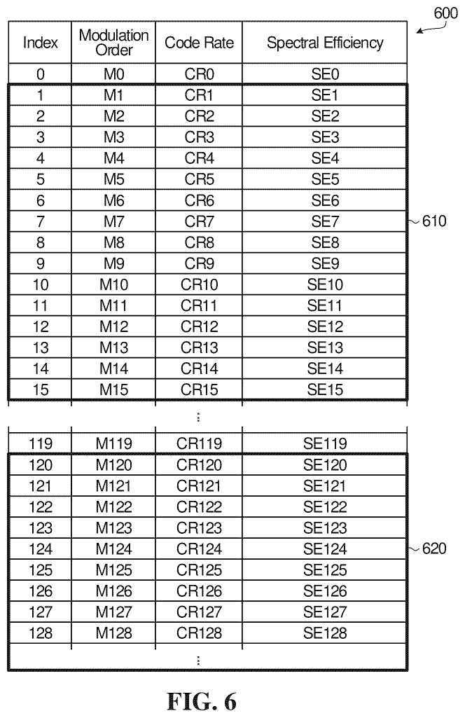

In some embodiments, some or all CQI tables associated with the configurations may be derived from a master CQI table and may be subset(s) of the master CQI table, as illustrated in FIG. 6. Referring to FIG. 6, the CQI table 610 is a subset of the master CQI table 600 and is associated with a configuration for a low bit resolution. The CQI table 620 is another subset of the master CQI table 600 and is associated with a configuration for a high bit resolution. The size of the master CQI table may be larger or smaller than the master CQI table 600 shown in FIG. 6. By having multiple CQI tables, each corresponding to a respective different bit resolution and/or sampling rate, the number of bits used to signal a CQI value may be reduced compared to having one large CQI table that has a large spread of CQI values covering all bit resolutions and/or sampling rates.

The apparatus may transmit, to the device, information related to the channel measurement that is associated with the operating configuration. The information transmitted to the device may be information from the CQI table associated with the operating configuration. The information from the CQI table associated with the operating configuration may be referred to as CQI value(s) and include information indicative of CQI index, modulation, code rate, (spectral) efficiency, and/or any combination thereof. The CQI value may be derived or selected by the apparatus from the CQI table associated with the operating configuration.

In some embodiments, the apparatus may transmit, to the device, one CQI value (e.g. CQI index) from the CQI table associated with the operating configuration. The CQI value to transmit to the device may be determined or calculated by the apparatus using the operating configuration. For example, the apparatus calculates the CQI value to transmit based on the bit resolution, sampling rate, and/or combination of bit resolution and sampling rate that is/are associated with the operating configuration. For example, the apparatus may receive a wireless reference signal and convert the reference signal to a digital reference signal using the operating configuration (e.g. using an ADC having the bit resolution and/or sampling rate associated with the operating configuration). The apparatus may then perform a channel measurement using the digital reference signal to obtain a measurement result. The apparatus may then map the measurement result to a CQI value in the CQI table that is associated with the operating configuration. The apparatus may then transmit that CQI value to the device.

In some embodiments, the apparatus may transmit, to the device, multiple CQI values (e.g. multiple CQI indices) from multiple CQI tables associated with multiple configurations for converting between analog and digital signals. In addition to the CQI value associated with the operating configuration, the apparatus may also transmit CQI value(s) associated with other configurations for converting between analog and digital signals. The additional CQI values associated with other configurations may be used by the device (e.g. TRP) for allocating resources and scheduling a transmission with the apparatus, when the apparatus and/or device performs a configuration change (e.g. switching from one configuration to another configuration).

In some embodiments, the apparatus may perform multiple channel measurements to obtain multiple CQI values, where each channel measurement is performed based on different (respective) configuration for converting between analog and digital signals. Each of the multiple CQI values obtained through multiple channel measurements may be associated with a respective configuration for converting between analog and digital signals. Then, in the similar manner illustrated above, the apparatus may transmit the multiple CQI values to the device so that the device can use the multiple CQI values for allocating resources and scheduling a transmission with the apparatus when the apparatus and/or device performs a configuration change (e.g. switching from one configuration to another configuration).

After the transmission of information related to the channel measurement performed by the apparatus (e.g. CQI values), the device may transmit control information scheduling a transmission with the apparatus, the control information allocating resources based on the information related to the channel measurement. The device may also transmit a modulation and coding scheme (MCS) value (e.g. modulation order, coding rate) to the apparatus as part of the control information for scheduling. The MCS value may be associated with the information related to the channel measurement (e.g. the MCS value may be based on the CQI value received from the apparatus).

The information related to the channel measurement performed by the apparatus (e.g. CQI values from CQI table) may be related to downlink channel quality and transmitted from the apparatus to the device. For example, the apparatus performs a channel measurement of the downlink channel using a downlink reference signal, and transmits a CQI value indicative of the downlink channel quality to the device. However, the device may not use the MCS value(s) associated with the downlink channel quality received from the apparatus, for a downlink transmission. Therefore, the device may need to transmit, to the apparatus, the MCS value(s) to be used for a downlink transmission, when the device schedules that downlink transmission. For example, the device may transmit an MCS index indicative of the MCS value to be used for the downlink transmission. The MCS index may be transmitted as part of the downlink control information (DCI) scheduling the downlink transmission. For DCI scheduling, the apparatus may use the MCS table associated with the operating configuration. The apparatus may need to know which MCS table is associated with the operating configuration so that the right MCS value(s) may be obtained using the MCS index received from the device. This is because there may be multiple MCS tables, where each MCS table is associated with a respective (different) configuration for converting between analog and digital signals at the apparatus. The same may apply for scheduled uplink transmissions, e.g. although the channel measurement performed by the apparatus may be based on a downlink signal (such as a downlink reference signal), it may be assumed that the uplink channel quality is similar to the downlink channel quality, such that the channel measurement may be used by the device to determine an MCS value to send to the apparatus when the device is scheduling an uplink transmission for the apparatus.

In some embodiments, each configuration for converting between analog and digital signals may be associated with information related to a modulation and coding scheme (MCS) value. The MCS value may be selected or derived from a modulation and coding scheme (MCS) table. Each MCS table may be associated with at least one configuration for converting between analog and digital signals at the apparatus. Put another way, multiple configurations for converting between analog and digital signals at the apparatus may be associated with the same MCS table. Mapping between the configurations and the MCS table(s) may be pre-defined or pre-configured for example by the device (e.g. TRP).

Some example MCS tables are provided below in Tables 6A to 7B. Tables 6A and 6B illustrate example MCS tables associated with configurations for high bit resolutions, and may be used for transmissions on a physical downlink shared channel (PDSCH) and/or a physical uplink shared channel (PUSCH). Tables 7A and 7B illustrate example MCS tables associated with configurations for low bit resolutions, and may be used for transmissions on a PDSCH and/or PUSCH.

TABLE 6A
MCS table associated with configuration for high bit resolution

| MCS Index | Modulation | Target code | Spectral |
|---|---|---|---|
| I_{MCS} | Order Qₘ | Rate R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 6B
MCS table associated with configuration for high bit resolution

| MCS Index | Modulation | Target code | Spectral |
|---|---|---|---|
| I_{MCS} | Order Qₘ | Rate R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

TABLE 7A
MCS table associated with configuration for low bit resolution

| MCS Index | Modulation | Target code | Spectral |
|---|---|---|---|
| I_{MCS} | Order Qₘ | Rate R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 567 | 2.4063 |
| 21 | 4 | 616 | 2.5664 |
| 22 | 4 | 666 | 2.7305 |
| 23 | 4 | 719 | 3.0293 |
| 24 | 4 | 772 | 3.3223 |
| 25 | 4 | 822 | 3.6094 |
| 26 | 4 | 873 | 3.9023 |
| 27 | 4 | 910 | 4.2129 |
| 28 | 4 | 948 | 4.5234 |

| | | |
|---|---|---|
| 29 | 2 | reserved |
| 30 | 4 | reserved |
| 31 | 6 | reserved |

TABLE 7B
MCS table associated with configuration for low bit resolution

| MCS Index | Modulation | Target code | Spectral |
|---|---|---|---|
| I_{MCS} | Order Qₘ | Rate R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 4 | 822 | 3.3223 |
| 25 | 4 | 873 | 3.6094 |
| 26 | 4 | 910 | 3.9023 |
| 27 | 4 | 948 | 4.5234 |

| | | |
|---|---|---|
| 28 | q | reserved |
| 29 | 2 | reserved |
| 30 | 4 | reserved |
| 31 | 6 | reserved |

As shown above in Tables 6A to 6B, MCS tables associated with configurations for high bit resolutions may include entries with modulation orders up to 64 QAM, similar to the one in new radio (NR). Such MCS tables might not include entries with modulation order of BPSK (Binary Phase-Shift Keying). In general, the entries in the MCS tables associated with configurations for high bit resolutions have higher spectral efficiency values. On the other hand, as shown above in Tables 7A to 7B, MCS tables associated with configurations for low bit resolutions may include entries with modulation orders up to 16 QAM. There may be some entries with modulation order of BPSK. In general, the entries in the MCS tables associated with configurations for low bit resolutions have lower spectral efficiency values.

Each MCS table may be a respective different table comprising different available modulation orders, different code rates, or both, for example as shown above in Tables 6A to 7B. In some embodiments, the different available modulation orders may include some or all of BPSK, QPSK (Quadrature Phase-Shift Keying), 16 QAM, and 64 QAM.

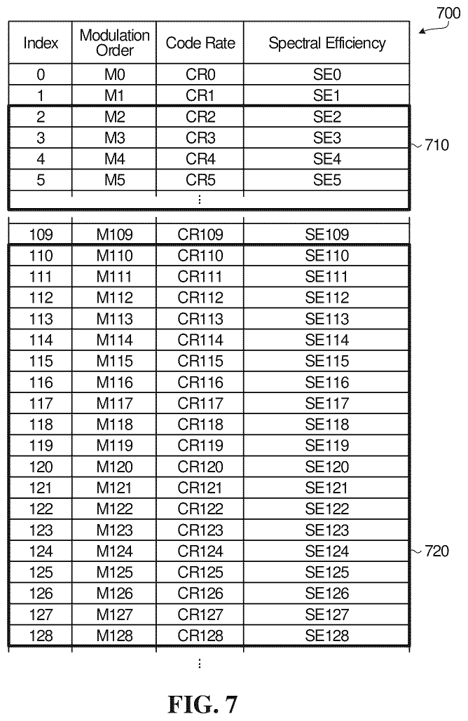

In some embodiments, some or all MCS tables associated with the configurations may be derived from a master MCS table and may be subset(s) of the master MCS table, as illustrated in FIG. 7. Referring to FIG. 7, the MCS table 710 is a subset of the master MCS table 700 and is associated with a configuration for a low bit resolution. The MCS table 720 is another subset of the master MCS table 700 and is associated with a configuration for a high bit resolution. The size of the master MCS table may be larger or smaller than the master MCS table 700 shown in FIG. 7. By having multiple MCS tables, each corresponding to a respective different bit resolution and/or sampling rate, the number of bits used to signal an MCS value may be reduced compared to having one large MCS table that has a large spread of MCS values covering all bit resolutions and/or sampling rates.

The device may transmit, to the apparatus, a modulation and coding scheme (MCS) value associated with a reference configuration for converting between analog and digital signals at the apparatus. The reference configuration may be the operating configuration or another configuration that differs from the operating configuration. The MCS value transmitted to the apparatus may be selected or derived from the MCS table associated with the reference configuration. The MCS value may be selected by the device. The MCS table associated with the reference configuration may be one of a plurality of MCS tables, where each MCS table may be associated with at least one configuration for converting between analog and digital signals at the apparatus. The MCS value may include information indicative of MCS index, modulation order, code rate, spectral efficiency, and/or any combination thereof.

When the apparatus operates on a low bit resolution configuration for the digital-to-analog signal conversion, the uplink signal transmitted by the apparatus would have lower quality, and therefore the device may schedule the uplink transmission in association with a lower MCS value. If the apparatus operates on a high bit resolution configuration for the digital-to-analog signal conversion, the uplink signal transmitted by the apparatus would have higher quality, and therefore the device may schedule the uplink transmission in association with a higher MCS value.

As noted above, in some embodiments, the apparatus may operate on the same operating configuration for an analog-to-digital signal conversion and for a digital-to-analog signal conversion. However, in some embodiments, the apparatus may operate on different operating configurations for an analog-to-digital signal conversion and for a digital-to-analog signal conversion. For example, when the apparatus wants to receive downlink signals with higher bit resolution, but wants to transmit signals with lower bit resolution for power savings. The total number of configurations for the analog-to-digital signal conversion may be same as or different from the total number of configurations for the digital-to-analog signal conversion.

In some embodiments where the apparatus uses the same configuration for an analog-to-digital signal conversion and a digital-to-analog signal conversion, the reference configuration for converting between analog and digital signals at the apparatus may be the operating configuration on which the apparatus would operate. In other words, if the apparatus uses the same bit resolution and/or the same sampling rate for an analog-to-digital signal conversion and a digital-to-analog signal conversion, the reference configuration may be the operating configuration on which the apparatus would operate.

In some embodiments where the apparatus may use different configurations for an analog-to-digital signal conversion and a digital-to-analog signal conversion, there are multiple ways of determining the reference mode as explained below or elsewhere in the present disclosure.

In some embodiments, the reference configuration may be the configuration associated with lower bit resolution or sampling rate among the operating configuration for the analog-to-digital signal conversion and the operating configuration for the digital-to-analog signal conversion. For example, when the operating configuration for the analog-to-digital signal conversion is associated with Ni bit resolution and the operating configuration for the digital-to-analog signal conversion is associated with N2 bit resolution, the reference configuration may be associated with N3 bit resolution, where N3 is the lower of N1 and N2. The apparatus may use the MCS table associated with this reference configuration for uplink and downlink scheduling. As such, the reference configuration might not be the same as at least one of the operating configurations. For example, the bit resolution and/or sampling rate associated with the reference configuration may be lower or higher than the bit resolution and/or sampling rate associated with at least one of the operating configurations.

In some embodiments, two different reference configurations may be used. For example, when the operating configuration for the analog-to-digital signal conversion is associated with N1 bit resolution and the operating configuration for the digital-to-analog signal conversion is associated with N2 bit resolution, the apparatus may use the MCS table associated with the N1 bit resolution configuration (i.e. the configuration associated with Ni bit resolution) for downlink scheduling, and use the MCS table associated with the N2 bit resolution configuration (i.e. the configuration associated with N2 bit resolution) for uplink scheduling. It should be noted that the apparatus may covert an analog signal to a digital signal for downlink transmission and convert a digital signal to an analog signal for uplink transmission.

According to some embodiments, there are one or multiple device configurations for converting between analog and digital signals at a device (e.g. TRP). The device may operate and convert analog and digital signals based on one of the device configurations. The device configuration on which the device would operate may be referred to as device operating configuration (for converting between analog and digital signals at the device).

A device (e.g. TRP) may configure the one or multiple device configurations for converting between analog and digital signals at the device, as illustrated below or elsewhere in the present disclosure.

In some embodiments, the device explicitly defines a plurality of device configurations for converting between analog and digital signals at the device. Each device configuration for converting between analog and digital signals at the device may be associated with a respective bit resolution (e.g. N bits) used by the device when converting between analog and digital signals, a respective sampling rate (e.g. Fs) used by the device, and/or a respective combination of bit resolution and sampling rate used by the device. As such, different device configurations may have different bit resolutions, different sampling rates, and/or different combinations of bit resolutions and sampling rates.

In some embodiments, each device configuration for converting between analog and digital signals may be associated with one or more channel quality indicator (CQI) tables (i.e. tables for CQI values) or one or more channel state information (CSI) tables (i.e. tables for CSI values). Each CQI table and/or each CSI table may be associated with at least one configuration for converting between analog and digital signals at the device. Put another way, multiple configurations for converting between analog and digital signals at the device may be associated with the same CQI and/or CSI table. Mapping between the configurations and the CQI/CSI table(s) may be pre-defined or pre-configured for example by the device (e.g. TRP).

In some embodiments, each device configuration for converting between analog and digital signals may be associated with one or more modulation and coding scheme (MCS) tables (i.e. a table of MCS values). Each MCS table may be associated with at least one configuration for converting between analog and digital signals at the device. Put another way, multiple configurations for converting between analog and digital signals at the device may be associated with the same MCS table. Mapping between the configurations and the MCS table(s) may be pre-defined or pre-configured for example by the device (e.g. TRP).

The device may transmit, to an apparatus (e.g. UE), information indicative of device configurations for converting between analog and digital signals at the device. In some embodiments, the information indicative of the device configurations may be explicit indications of the device configurations. In some embodiments, the information indicative of the device configurations may include at least one of: indications of CQI and/or CSI tables associated with the respective device configurations, or indications of MCS tables associated with the respective device configuration.

The device may transmit the information indicative of the device configurations using broadcast signaling, radio resource control (RRC), medium access control (MAC) control element (MAC-CE), or downlink control information (DCI).

One of the plurality of device configurations may be configured by the device as an operating device configuration which is the configuration on which the device would operate. For example, the device may select one of the device configurations for converting between analog and digital signals at the device and indicate it as a device operating configuration. As such, the device operating configuration, like other device configurations, is associated with a bit resolution (e.g. N bits) used by the device when converting between analog and digital signals, a sampling rate (e.g. Fs) used by the device, and/or a combination of bit resolution and sampling rate used by the device.

The device may transmit, to an apparatus (e.g. UE), information indicative of a device operating configuration for converting between analog and digital signals at the device. The information indicative of the device operating configuration may include at least one of: an indication of a table of channel quality values (e.g. CQI table) associated with the device operating configuration, or an indication of an MCS table associated with the device operating configuration. In this way, the apparatus may know which CQI table and/or MCS table is/are associated with the device operating configuration so that the apparatus may obtain the right CQI and/or MCS values from the right CQI table and/or MCS table associated with the device operating configuration.

In some embodiments, the device does not explicitly define device configurations for converting between analog and digital signals at the device. Given that there are a plurality CQI tables and/or MCS tables but no explicitly defined device configurations, the device may transmit an indication, to the apparatus, of which CQI table and/or MCS table the apparatus is to use. In this way, the apparatus may obtain the right CQI and/or MCS values from the right CQI table and/or MCS table. For example, when the device operates on low bit resolution device configuration for the analog-to-digital signal conversion, the device transmits, to the apparatus, an indication that the apparatus is to use a low bit resolution CQI table and/or low bit resolution MCS table for a transmission to the device. In the MCS table for the low bit resolution, the maximum supported modulation order may be 16 QAM, whereas in the MCS table for high bit resolution, the maximum supported modulation order may be 64 QAM.

It may be noted that switching a device configuration (performing a device configuration change) for converting between analog and digital signals at the device may be left to internal implementation of the device and the apparatus might only be notified if the switch results in a different CQI and/or MCS table to be used by the apparatus, in which case the apparatus might only be told to switch to the different CQI and/or MCS table. The apparatus might not be told the reason why the different CQI and/or MCS table is to be used.

In some embodiments, the apparatus may perform a configuration change. The configuration change process may include deactivating a former configuration for converting between analog and digital signals at the apparatus and activating a (new) operating configuration for converting between analog and digital signals at the apparatus. The former configuration may be the configuration on which the apparatus (currently) operates prior to the configuration change. In other words, the former configuration may be a former operating configuration for converting between analog and digital signals at the apparatus. After the former configuration is deactivated, the (new) operating configuration may be activated based on the information indicative of the operating configuration received from the device. There may be no deactivation step in the configuration change, if no configuration was previously configured (e.g. when an initial configuration is performed). Put another way, the former configuration may be null, if no configuration was previously configured. In some embodiments, the configuration change process may include modifying the operating configuration on which the apparatus (currently) operates. For example, the bit resolution and/or sampling rate associated with the operating configuration may be changed through the configuration change process. In some embodiments, the configuration change process may include modifying other configurations (i.e. configurations that are not the operating configuration) for converting between analog and digital signals at the apparatus. In some embodiments, the configuration change process may include reconfiguring the configuration(s) for converting between analog and digital signals at the apparatus. The reconfiguring process may include a process that is similar to the radio resource control (RRC) reconfiguration process in the 3rd Generation Partnership Project (3GPP) new radio (NR) protocol.

As noted above, one of the plurality of configurations may be configured by the device as an operating configuration. The device may explicitly or implicitly configure the operating configuration for the apparatus. The device may transmit, to the apparatus, information indicative of the (new) operating configuration on which the apparatus is to operate upon a configuration change. The information indicative of the operating configuration may explicitly or implicitly indicate the operating configuration. The device may transmit the information indicative of the operating configuration upon a request of the apparatus. After the apparatus receives the information (explicitly or implicitly) indicative of the operating configuration, the apparatus may perform a configuration change, which may include the deactivation and/or activation processes as explained above, based on the received information (explicitly or implicitly) indicative of the operating configuration. In some cases, the apparatus may not perform the configuration change, as the configuration on which the apparatus is currently operating is the same as the configuration indicated in the received information.

In some embodiments, the device may transmit, to the apparatus, the information indicative of the (new) operating configuration which includes an explicit indication of the (new) operating configuration on which the apparatus is to operate. The information including the explicit indication of the (new) operating configuration may be transmitted using broadcast signaling, radio resource control (RRC), medium access control (MAC) control element (MAC-CE), or downlink control information (DCI). Therefore, the configuration change may occur dynamically (e.g. using DCI) or semi-statically (e.g. using RRC signaling) depending upon the scenario or implementation.

In some embodiments, the device may transmit, to the apparatus, the information indicative of the operating configuration which includes an implicit indication of the (new) operating configuration on which the apparatus is to operate. The implicit indication for the configuration change is further discussed below and elsewhere in the present disclosure. Note that the implicit indication might also be transmitted using broadcast signaling, radio resource control (RRC), medium access control (MAC) control element (MAC-CE), or downlink control information (DCI).

The implicit indication of the (new) operating configuration may include information related to power consumption mode of the apparatus. The apparatus may perform a configuration change based on the information related to the power consumption mode. The information related to the power consumption mode may indicate the (new) operating configuration on which the apparatus is to operate, relying on the mappings between the configurations for converting analog and digital signals at the apparatus and the power consumption mode of the apparatus. For example, when the apparatus receives information that the apparatus is to change to the power saving mode, then the apparatus may also perform the configuration change, switching to the configuration for the low bit resolution, based on the mappings between the configurations and the power consumption mode. The mappings between the configurations and the power consumption mode of the apparatus may be preconfigured or predetermined by the device. For example, a configuration for a low bit resolution may be associated with the power saving mode, and a configuration for a high bit resolution may be associated with the regular power mode.

The implicit indication of the (new) operating configuration may include information related to type of the apparatus. The apparatus may perform an initial configuration or configuration change (e.g. switching configuration, modifying configuration, etc.) based on the information related to the type of the apparatus. The information related to the type of the apparatus may indicate the operating configuration on which the apparatus is to operate, relying on the mappings between the configurations for converting analog and digital signals at the apparatus and the type of the apparatus. The mappings between the configurations and the type of the apparatus may be preconfigured or predetermined by the device. For example, a configuration for a low bit resolution may be associated with low-cost apparatuses, and a configuration for a high bit resolution may be associated with high capability apparatuses. In some embodiments, the apparatus may use the information related to type of the apparatus only for the purpose of the (initial) configuration, as the capability of the apparatus does not change.

The implicit indication of the (new) operating configuration may include information related to scheduled MCS used by the apparatus (e.g. the MCS indicated in control information scheduling a transmission to or from the apparatus). The information related to the scheduled MCS may indicate the (new) operating configuration on which the apparatus is to operate, relying on the mappings between the configurations for converting analog and digital signals at the apparatus and the scheduled MCS values. For example, when the apparatus receives information related to the scheduled MCS index, then apparatus may also perform the configuration change (e.g. switching to the (new) operating configuration) based on the mappings between the configurations and the scheduled MCS values. The mappings between the configurations and the scheduled MCS values may be preconfigured or predetermined by the device. Example mappings between configurations for converting between analog and digital signals and the scheduled MCS indices are illustrated below in Table 8.

TABLE 8
mappings between configurations for converting between
analog and digital signals and scheduled MCS indices

| | Configurations for converting |
|---|---|
| Scheduled MCS index | between analog and digital signals |
| I_{MCS} <= Threshold_1 | Configuration for high bit resolution |
| Threshold_1 < I_{MCS} <= | Configuration configured by RRC; or |
| Threshold_2 | Configuration for low bit resolution |
| I_{MCS} > Threshold_2 | Configuration for high bit resolution |

As shown above, the configuration for high bit resolution may be mapped to high MCS indices (e.g. I_{MCS}>Threshold_2) because high MCS index is indicative of high throughput requirement and the configuration for high bit resolution is needed to achieve high throughput. The configuration for high bit resolution may be also mapped to low or ultra-low MCS indices (e.g. I_{MCS}<=Threshold_1) to improve signal-to-noise ratio (SNR) performance. The MCS indices in the other range (e.g. Threshold_1<I_{MCS}<=Threshold_2) may be mapped to the configuration configured by radio resource control (RRC) or configuration for low bit resolution.

The implicit indication for the (new) operating configuration may include information related to number of resource blocks. The information related to the number of resource blocks may (implicitly) indicate the (new) operating configuration on which the apparatus is to operate, relying on the mappings between the configurations for converting analog and digital signals at the apparatus and the number of resource blocks. For example, when the apparatus receives information related to the number of scheduled resource blocks, then the apparatus may also perform the configuration change (e.g. switching to the (new) operating configuration) based on the mappings between the configurations and the number of scheduled resource blocks. The mappings between the configurations and the number of scheduled resource blocks may be preconfigured or predetermined by the device.

In some embodiments, the configuration for high bit resolution may be used for large scheduled bandwidth. When the number of scheduled resource blocks are greater than a certain threshold, the apparatus may operate on the configuration for high bit resolution. When the number of scheduled resource blocks are equal to or less than the threshold, the apparatus may operate on the configuration for low bit resolution. The mappings between the configurations for converting between analog and digital signals and the number of scheduled resource blocks may be configured as shown in Table 9A. The rationale behind the mappings such as those shown in Table 9A may be that the configuration for high bit resolution may be used for larger scheduled bandwidth in order to increase throughput. The configuration for low bit resolution may be used for smaller scheduled bandwidth and/or packets having smaller size.

TABLE 9A
mappings between configurations for converting between analog
and digital signals and scheduled resource blocks

| Number of scheduled | Configurations for converting |
|---|---|
| resource blocks (RBs) | between analog and digital signals |
| RBs <= Threshold | Configuration configured by RRC; or |
| | Configuration for low bit resolution |
| RBs > Threshold | Configuration for high bit resolution |

On the other hand, in some embodiments, the configuration for high bit resolution may be used for small scheduled bandwidth and the configuration for low bit resolution may be used for large scheduled bandwidth, as illustrated in Table 9B. The rationale behind the mappings such as those shown in Table 9B may be that the device (e.g. TRP) may use more number of scheduled resource blocks to compensate SNR loss associated with the configuration for low bit resolution, and to achieve power saving.

TABLE 9B
mappings between configurations for converting between analog
and digital signals and scheduled resource blocks

| Number of scheduled | Configurations for converting |
|---|---|
| resource blocks (RBs) | between analog and digital signals |
| RBs <= Threshold | Configuration for high bit resolution |
| RBs > Threshold | Configuration for low bit resolution |

The implicit indication of the (new) operating configuration may include information related to transport block size. The apparatus may perform the configuration change based on the information related to the transport block size. The information related to the transport block size may indicate the (new) operating configuration on which the apparatus is to operate, relying on the mappings between the configurations for converting analog and digital signals at the apparatus and the transport block size. The mappings between the configurations and the transport block size may be preconfigured or predetermined by the device. For example, a configuration for a low bit resolution may be associated with the transport block size that is equal to or less than a threshold to achieve power saving for small packets, and a configuration for a high bit resolution may be associated with the transport block size that is greater than the threshold to obtain high throughput for large packets.

The implicit indication of the (new) operating configuration may include information related to number of transport blocks. The apparatus may perform the configuration change based on the information related to the number of transport blocks. The information related to the number of transport blocks may indicate the (new) operating configuration on which the apparatus is to operate, relying on the mappings between the configurations for converting analog and digital signals at the apparatus and the number of transport blocks. The mappings between the configurations and the number of transport blocks may be preconfigured or predetermined by the device. For example, a configuration for a low bit resolution or a configuration configured by RRC may be used when only one transport block is scheduled, and a configuration for a high bit resolution may be used when two or more transport blocks are scheduled.

The implicit indication of the (new) operating configuration may include information related to number of layers for data transmission. The apparatus may perform the configuration change based on the information related to the layers. The information related to the number of layers may indicate the (new) operating configuration on which the apparatus is to operate, relying on the mappings between the configurations for converting analog and digital signals at the apparatus and the number of layers. The mappings between the configurations and the number of layers may be preconfigured or predetermined by the device. For example, a configuration for a low bit resolution or a configuration configured by RRC may be used when the number of scheduled layers is equal to or less than a threshold, and a configuration for a high bit resolution may be used when the number of scheduled layers is greater than the threshold. One example of mappings between configurations for converting between analog and digital signals and number of scheduled layers is provided in Table 10 below.

TABLE 10
mappings between configurations for converting between analog
and digital signals and number of scheduled layers

| Number of layers | Configurations for converting |
|---|---|
| (DMRS ports) | between analog and digital signals |
| layers <= Threshold | Configuration configured by RRC; |
| | Configuration for low bit resolution |
| layers > Threshold | Configuration for high bit resolution |

The implicit indication of the (new) operating configuration may include information related to carrier frequency range. The information related to the number of layers may indicate the (new) operating configuration on which the apparatus is to operate, relying on the mappings between the configurations for converting analog and digital signals at the apparatus and the carrier frequency range. The mappings between the configurations and the carrier frequency range may be preconfigured or predetermined by the device. For example, a configuration for a low bit resolution or a configuration configured by RRC may be mapped to a high frequency band in order to achieve power saving, and a configuration for a high bit resolution may be mapped to a low frequency band in order to meet throughput requirement.

While the information included in the implicit indication of the (new) operating configuration is illustrated above based only on two configurations for converting between analog and digital signals (i.e. configurations for high bit resolution and low bit resolution), it should be noted that there may be more than two configurations for converting between analog and digital signals. For example, there may be three configurations for converting between analog and digital signals mapped to the number of scheduled layers, as shown in Table 11.

TABLE 11
mappings between configurations for converting between analog
and digital signals and number of scheduled layers

| Number of layers | Configurations for converting |
|---|---|
| (DMRS ports) | between analog and digital signals |
| layers <= Threshold_1 | Configuration configured by RRC; |
| | Configuration for low bit resolution |
| Threshold_1 < layers <= | Configuration for medium bit resolution |
| Threshold_2 | |
| layers > Threshold_2 | Configuration for high bit resolution |

In some embodiments, some configurations for converting between analog and digital signals (including the operating configuration and/or reference configuration) may be specific to apparatus, carrier or spectrum range, bandwidth part (BWP), radio frequency (RF) chain, transmitting (Tx) antenna, Tx antenna group, receiving (Rx) antenna, or Rx antenna group.

For example, when configurations for converting between analog and digital signals are configured specific to an apparatus and the apparatus uses multiple carriers (e.g. in carrier aggregation), the configurations for each carrier may be the same.

For example, when configurations for converting between analog and digital signals are configured specific to a carrier or spectrum range (carrier-specific or spectrum-range specific configurations), the device may configure the configurations for the apparatus per carrier or per spectrum range. In other words, different configurations may be configured for different carriers or different spectrum ranges.

For example, when configurations for converting between analog and digital signals are configured specific to a bandwidth part (BWP), the device may configure the configurations for the apparatus per BWP, and the configuration change may be performed upon switching the BWP.

For example, when configurations for converting between analog and digital signals are configured specific to a radio frequency (RF) chain, RF channel or RF link, the device may configure the configurations for the apparatus such that configurations for low bit resolution are mapped to some RF chains for power saving and configurations for high bit resolution are mapped to other RF chains for better communication performance.

For example, the device may configure configurations for converting between analog and digital signals specific to a transmitting (Tx) antenna, Tx antenna group, receiving (Rx) antenna, or Rx antenna group. If no configuration for converting between analog and digital signals is configured, a predetermined default configuration (e.g. configuration for high bit resolution) may be used.

As noted above, in some embodiments, the device may transmit the information indicative of the configuration change upon a request of the apparatus. Put another way, the device may approve the request of the apparatus to change the operating configuration for converting between analog and digital signals at the apparatus. The request for the configuration change may include at least one of preferred configuration for converting between analog and digital signals at the apparatus, or preferred MCS level of the apparatus.

For example, the apparatus may send a configuration change request to the device based on, for example, available battery power level. The configuration change request may include a preferred configuration for in order to assist the device determining the (new) operating configuration for converting between analog and digital signals at the apparatus. In addition, if the preferred configuration differs from the current operating configuration (e.g. operating configuration on which the apparatus operates prior to the configuration change), the configuration change request may further include a preferred MCS level or index. For example, when the apparatus requests to change from a configuration for high bit resolution to a configuration for low bit resolution, the configuration change request may include an MCS offset (e.g. if MCS index is N for the configuration for high bit resolution ADC, a preferred MCS index for the configuration for low bit resolution may be N−offset).

The apparatus may transmit the request (e.g. configuration change request signal) for the configuration change using dedicated scheduling request resource, MAC-CE, physical uplink control channel (PUCCH), or RRC reconfiguration request.

In some embodiments, the configuration change may be performed in a manner that differs from the manners illustrated above. The apparatus may inform the device that the apparatus is in a particular state (e.g. low power state). The apparatus may perform the configuration change (e.g. switching to a configuration for low bit resolution due to the low power at the apparatus). The device may (implicitly) know that the apparatus has performed the configuration change, as the device received the information that the apparatus is in the particular state (e.g. lower power state). The apparatus may operate based on the changed configuration (e.g. the configuration for low bit resolution) in accordance with predetermined protocols. For example, the apparatus may operate on the configuration for low bit resolution for a predetermined time period. The predetermine time period may be tracked by both the apparatus and device using a timer. After the predetermined time period, the apparatus may switch back to the original configuration (e.g. configuration for high bit resolution). The device may implicitly know that the apparatus has changed back to the original configuration, when the timer expires.

In some embodiments, the apparatus may perform the configuration change after a configuration change delay. For example, if the device transmits an indication to perform a configuration change at time T, the apparatus may perform the configuration change at time (T +configuration change delay). The configuration change delay may be determined based on one or more factors. By knowing the configuration change delay, the device will know exactly when the apparatus will start using the new operating configuration.

In some embodiments, the configuration change delay may be determined based on capability of the apparatus for converting between analog and digital signals. For example, there may be no delay (e.g. 0 ms) for apparatuses with high capability for converting between analog and digital signals, and some delay (e.g. 2 ms) for apparatuses with low capability for converting between analog and digital signals.

In some embodiments, the configuration change delay may be determined based on a bit resolution associated with the former configuration and/or a bit resolution associated with the operating configuration. For example, a certain configuration change delay may be applied when the configuration is changed from the 16-bit resolution configuration to the 8-bit resolution configuration, and a different configuration change delay may be applied when the configuration is changed from the 16-bit resolution configuration to the 1-bit resolution configuration. This is shown in Table 12 below. Each configuration change delay may be predetermined or reported by an apparatus (e.g. within information related to capability of the apparatus for converting between analog and digital signals).

TABLE 12
Example configuration change delays
for different configuration changes

| Switching-from | Switching-to | Configuration change |
|---|---|---|
| configuration | configuration | delay (μs) |
| Configuration for 16 bit | Configuration for 8 bit | M1 |
| resolution | resolution | |
| Configuration for 16 bit | Configuration for 1 bit | M2 |
| resolution | resolution | |

In some embodiments, the configuration change delay may be determined based on a spectrum range (carrier spectrum). Different configuration change delays may be configured for high frequency and low frequency.

In some embodiments, the configuration change delay may be determined based on numerology of an active bandwidth part (BWP). An example is shown below in Table 13.

TABLE 13
Example configuration change delays for different numerologies

| Numerology | Configuration change delay (μs) |
|---|---|
| Numerology 1 (e.g. 15 kHz | M1 |
| subcarrier spacing) | |
| Numerology 2 (e.g. 30 kHz | M2 |
| subcarrier spacing) | |

In some embodiments, the configuration change delay may be determined based on number of transmitting (Tx) antennas and/or number of receiving (Rx) antennas. An example is shown below in Table 14.

TABLE 14
Example configuration change delays
for different number of antennas

| Number of Tx (Rx) antennas | Configuration change delay (μs) |
|---|---|
| 4 | M1 |
| 8 | M2 |

In some embodiments, the configuration change delay may be determined based on number of radio frequency (RF) chains. An example is shown below in Table 15.

TABLE 15
Example configuration change delays
for different number of RF chains

| Number of RF chains | Configuration change delay (μs) |
|---|---|
| 2 | M1 |
| 8 | M2 |

In some embodiments, the configuration change delay may be determined based on carrier bandwidth or active BWP bandwidth. An example is shown below in Table 16.

TABLE 16
Example configuration change delays
for different carrier bandwidths

| Carrier bandwidth | Configuration change delay (μs) |
|---|---|
| 50 MHz | M1 |
| 100 MHz | M2 |

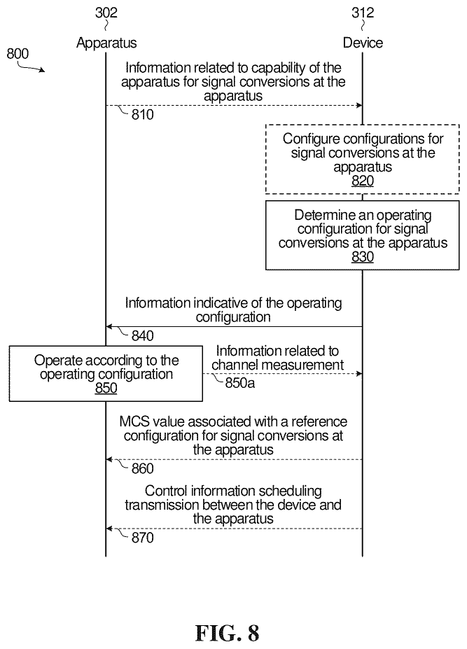

FIG. 8 is a flow diagram illustrating an example process 800 for adapting configuration for converting between analog and digital signals at the apparatus 302, in accordance with embodiments of the present disclosure. In FIG. 8, the apparatus 302 may be a UE, and the device 312 may be a TRP.

At step 810, the apparatus 302 may transmit, to the device 312, information related to capability of the apparatus 302 for converting between analog and digital signals at the apparatus 302.

At step 820, the device 312 may configure a plurality of configurations for converting between analog and digital signals at the apparatus 302. Each configuration may be associated with at least one of: a respective bit resolution used by the apparatus 302 when converting between analog and digital signals, a respective sampling rate used by the apparatus 302, or a respective combination of bit resolution and sampling rate used by the apparatus 302. In some embodiments, the configuring process may include configuring mappings between each of the plurality of configurations and at least one of the respective bit resolution, the respective sampling rate, or the respective combination of bit resolution and sampling rate.

At step 830, the device 312 may determine an operating configuration for converting between analog and digital signals at the apparatus 302. The operating configuration may be a configuration for converting between analog and digital signals on which the apparatus 302 would operate. The operating configuration may be associated with at least one of: a bit resolution used by the apparatus 302 when converting between analog and digital signals, a sampling rate used by the apparatus 302, or a combination of bit resolution and sampling rate used by the apparatus 302. In some embodiments, the process of determining the operating configuration may include selecting the operating configuration from the plurality of configurations for converting between analog and digital signals at the apparatus 302.

At step 840, the device 312 may transmit, to the apparatus 302, information indicative of the operating configuration.

At step 850, after or in response to receiving the information indicative of the operating configuration, the apparatus 302 may operate according to the operating configuration to which the received information indicative of the operating configuration is related.

At step 850a, the apparatus 302 may transmit, to the device 302, information related to channel measurement performed by the apparatus. The information related to the channel measurement may be associated with the operating configuration. In some embodiments, the information related to the channel measurement may be further associated with another configuration for converting between analog and digital signals at the apparatus 302. In some embodiments, the information related to the channel measurement may include information from one or more channel quality indicator (CQI) tables. The information from the one or more CQI tables may include a CQI value. Each of the one or more CQI tables may be associated with at least one configuration for converting between analog and digital signals at the apparatus 302. The CQI value may be from a CQI table associated with the operating configuration. The CQI table associated with the operating configuration may be one of the one or more CQI tables. Each of the one or more CQI tables may be a respective different table comprising different available modulation orders, different code rates, or both.

In some embodiments, step 850a may be part of step 850.

At step 860, the device 312 may transmit, to the apparatus 302, a modulation and coding scheme (MCS) value associated with a reference configuration for converting between analog and digital signals at the apparatus 302.

The modulation and coding scheme (MCS) value associated with the reference configuration may be determined by the device 312 based on the information related to the channel measurement for the scheduled transmission with the apparatus 302. In some embodiments, the MCS value may be selected from an MCS table associated with the reference configuration. The MCS table associated with the reference configuration may be one of a plurality of MCS tables. Each of the plurality of MCS tables may be associated with at least one configuration for converting between analog and digital signals at the apparatus. Each of the plurality of MCS tables may be a respective different table comprising different available modulation orders, different code rates, or both.

The reference configuration may be configured by the device. In some embodiments, the reference configuration may be the operating configuration. In some embodiments, the reference configuration may differ from the operating configuration.

At step 870, the device 312 may transmit, to the apparatus 302, control information scheduling a transmission with the apparatus 302. The control information may allocate resources based on the information related to the channel measurement. In some embodiments, step 860 may be part of step 870. That is, the device 312 may transmit control information to the apparatus 302, the control information scheduling a transmission, and the control information including an MCS value to be used for the transmission, where the MCS value is associated with the reference configuration (e.g. the MCS value is selected from an MCS table that corresponds to the configuration for converting between analog and digital signals at the apparatus 302).

It should be noted that some or all of steps 810, 820, 850a, 860, and 870 are optional steps.

FIG. 9 is a flow diagram illustrating an example process 900 for adapting configuration for converting between analog and digital signals at the device 312, in accordance with embodiments of the present disclosure. In FIG. 9, the apparatus 302 may be a UE, and the device 312 may be a TRP.

At step 910, the device 312 may determine a device operating configuration for converting between analog and digital signals at the device 312. The device operating configuration may be a device configuration for converting between analog and digital signals on which the device 312 would operate. The device operating configuration may be associated with at least one of: a device bit resolution used by the device 312 when converting between analog and digital signals, a device sampling rate used by the device 312, or a device combination of resolution and sampling rate used by the device 312.

In some embodiments, the process of determining the device operating configuration may include selecting the device operating configuration from a plurality of device configurations for converting between analog and digital signals at the device. Each device configuration may be associated with at least one of: a respective device bit resolution used by the device 312 when converting between analog and digital signals, a respective device sampling rate used by the device 312, or a respective device combination of bit resolution and sampling rate used by the device 312. The plurality of device configurations may be configured by the device 312.

At step 920, the device 312 may transmit, to the apparatus 302, information indicative of the device operating configuration. The information indicative of the device operating configuration may be transmitted using broadcast signaling, radio resource control (RRC), medium access control (MAC) control element (MAC-CE), or downlink control information (DCI).

In some embodiments, the information indicative of the device operating configuration may include at least one of: an indication of a table of channel quality values associated with the device operating configuration, or an indication of a table of modulation and coding scheme (MCS) values associated with the device operating configuration. The table of channel quality values may be a channel quality indicator (CQI) table associated with the device operating configuration. The CQI table may be one of a plurality of CQI tables, where each CQI table may be associated with at least one device configuration for converting between analog and digital signals at the device 312. In some embodiments, some CQI tables may be derived from a master CQI table and may be subset(s) of the master CQI table, as illustrated above and elsewhere in the present disclosure. The table of MCS values may be an MCS table associated with the device operating configuration. The MCS table may be one of a plurality of MCS tables, where each MCS table may be associated with at least one device configuration for converting between analog and digital signals at the device 312. In some embodiments, some MCS tables may be derived from a master MCS table and may be subset(s) of the master MCS table, as illustrated above and elsewhere in the present disclosure.

At step 930, the device 312 may operate based on the information indicative of the device operating configuration. In some embodiments, the process of operating may include the device using a channel quality indicator (CQI) table and/or modulation and coding scheme (MCS) table associated with the device operating configuration. Although not illustrated, the apparatus 302 also operates in accordance with the device operating configuration, e.g. using the CQI table and/or MCS table associated with the device operating configuration.

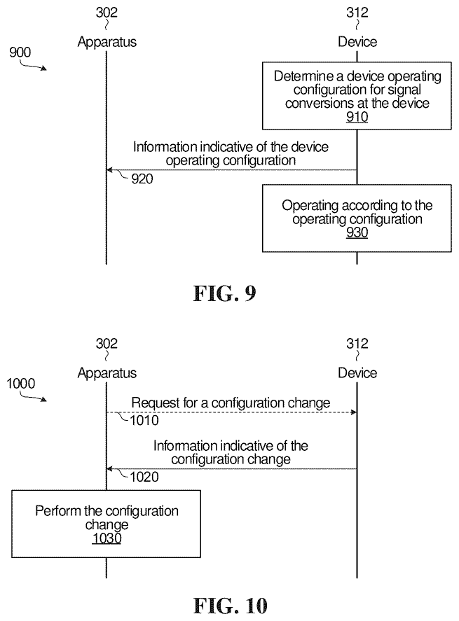

FIG. 10 is a flow diagram illustrating an example process 1000 for changing configuration for converting between analog and digital signals at the apparatus 302, in accordance with embodiments of the present disclosure. In FIG. 10, the apparatus 302 may be a UE, and the device 312 may be a TRP. In the process 1000, the configuration(s) and the operating configuration are similar to those illustrated above, for example in the process 800 of FIG. 8.

At step 1010, the apparatus 302 may transmit, to the device 312, a request for a configuration change. In some embodiments, the request for the configuration change may include at least one of: preferred configuration for converting between analog and digital signals at the apparatus, or preferred MCS level of the apparatus. The request for the configuration change may be transmitted using dedicated scheduling request resource, MAC-CE, physical uplink control channel (PUCCH), or RRC reconfiguration request. Step 1010 is an optional step.

At step 1020, the device 312 may transmit, to the apparatus 302, information indicative of the configuration change. In some embodiments, the information indicative of the configuration change may include an explicit indication for the apparatus 302 to perform the configuration change, and may be transmitted using broadcast signaling, radio resource control (RRC), medium access control (MAC) control element (MAC-CE), or downlink control information (DCI). In some embodiments, the information indicative of the configuration change may be implicit, e.g. it may be or include information related to at least one of: power consumption mode of the apparatus, type of the apparatus, scheduled MCS, number of resource blocks, transport block size, number of transport blocks, number of layers for data transmission, or carrier frequency range.

At step 1030, the apparatus 302 may perform the configuration change including: deactivating a former configuration for converting between analog and digital signals at the apparatus 302, and activating the operating configuration based on the information indicative of the configuration change.

In some embodiments, the apparatus 302 may perform the configuration change after a configuration change delay. The configuration change delay may be determined based on at least one of: capability of the apparatus for converting between analog and digital signals, a bit resolution associated with the former configuration, a bit resolution associated with the operating configuration, a spectrum range, numerology of an active bandwidth part (BWP), number of transmitting (Tx) antennas, number of receiving (Rx) antennas, number of radio frequency (RF) chains, or carrier bandwidth or active BWP bandwidth.

In some embodiments, the operating configuration may be specific to apparatus, carrier or spectrum range, BWP, RF chain, Tx antenna, Tx antenna group, Rx antenna, or Rx antenna group.

The embodiments described above are in the context of UEs communicating with a TRP. However, more generally, devices that wirelessly communicate with each other over time-frequency resources need not necessarily be one or more UEs communicating with a TRP. For example, two or more UEs may wirelessly communicate with each other over a sidelink using device-to-device (D2D) communication. As another example, two network devices (e.g. a terrestrial base station and a non-terrestrial base station, such as a drone) may wirelessly communicate with each other over a backhaul link. Embodiments are not limited to uplink and/or downlink communication. For example, in the embodiments above, the T-TRP 170 may be substituted with another device, such as a node in the network or a UE. The uplink/downlink communication may instead be sidelink communication. Therefore, as mentioned earlier, the apparatus 302 might be a UE or a network device (e.g. TRP), and the device 312 might be a UE or a network device (e.g. TRP).

### Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### Definitions of Acronyms & Glossaries

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE target UE
UCI Uplink control information
UE User Equipment
UL Uplink
UL-SCH Uplink shared channel

1. A method by an apparatus in a wireless network, comprising:
receiving, from a device, information indicating an operating configuration for converting between analog signals and digital signals at the apparatus; and
operating according to the operating configuration,
wherein the operating configuration is associated with at least one of:
a bit resolution used by the apparatus when converting between the analog signals and the digital signals, or
a sampling rate used by the apparatus.

2. The method of claim 1, wherein the operating configuration is selected from a plurality of operating configurations for converting between the analog signals and the digital signals at the apparatus, each operating configuration of the plurality of operating configurations associated with at least one of:
a respective bit resolution used by the apparatus when converting between the analog signals and the digital signals, or
a respective sampling rate used by the apparatus.

3. The method of claim 1, further comprising:
transmitting, to the device, information related to channel measurement performed by the apparatus, the information related to the channel measurement being associated with the operating configuration.

4. The method of claim 3, wherein the information related to the channel measurement includes information from one or more channel quality indicator (CQI) tables, the information from the one or more CQI tables including a CQI value, each CQI table of the one or more CQI tables being associated with at least one operating configuration for converting between the analog signals and the digital signals at the apparatus.

5. The method of claim 1, further comprising:
receiving, from the device, a modulation and coding scheme (MCS) value associated with a reference configuration for converting between the analog signals and the digital signals at the apparatus.

6. An apparatus in a wireless network comprising:
a memory to store processor-executable instructions; and
at least one processor to execute the processor-executable instructions to cause the apparatus to:
receive, from a device, information indicating an operating configuration for converting between analog signals and digital signals at the apparatus; and
operate according to the operating configuration,
wherein the operating configuration is associated with at least one of:
a bit resolution used when converting between the analog signals and the digital signals, or
a sampling rate.

7. The apparatus of claim 6, wherein the operating configuration is selected from a plurality of operating configurations for converting between the analog signals and the digital signals at the apparatus, each operating configuration of the plurality of operating configurations associated with at least one of:
a respective bit resolution used by the apparatus when converting between the analog signals and the digital signals,
a respective sampling rate used by the apparatus.

8. The apparatus of claim 6, wherein the processor-executable instructions when executed by the at least one processor further cause the apparatus to:
transmit, to the device, information related to channel measurement performed by the apparatus, the information related to the channel measurement being associated with the operating configuration.

9. The apparatus of claim 8, wherein the information related to the channel measurement includes information from one or more channel quality indicator (CQI) tables, the information from the one or more CQI tables including a CQI value, each CQI table of the one or more CQI tables being associated with at least one operating configuration for converting between the analog signals and the digital signals at the apparatus.

10. The apparatus of claim 6, wherein the processor-executable instructions when executed by the at least one processor further cause the apparatus to:
receive, from the device, a modulation and coding scheme (MCS) value associated with a reference configuration for converting between the analog signals and the digital signals at the apparatus.

11. A method by a device in a wireless network, comprising:
determining an operating configuration for converting between analog signals and digital signals at an apparatus; and
transmitting, to the apparatus, information indicating the operating configuration,
wherein the operating configuration is associated with at least one of:
a bit resolution used by the apparatus when converting between the analog signals and the digital signals, or
a sampling rate used by the apparatus.

12. The method of claim 11, wherein the determining the operating configuration includes:
selecting the operating configuration from a plurality of operating configurations for converting between the analog signals and the digital signals at the apparatus, each operating configuration of the plurality of operating configurations associated with at least one of:
a respective bit resolution used by the apparatus when converting between the analog signals and the digital signals, or
a respective sampling rate used by the apparatus.

13. The method of claim 11, further comprising:
receiving, from the apparatus, information related to channel measurement performed by the apparatus, the information related to the channel measurement being associated with the operating configuration; and
transmitting control information scheduling a transmission with the apparatus, the control information allocating resources based on the information related to the channel measurement.

14. The method of claim 13, wherein the information related to the channel measurement includes information from one or more channel quality indicator (CQI) tables, the information from the one or more CQI tables including a CQI value, each CQI table of the one or more CQI tables being associated with at least one configuration for converting between the analog signals and the digital signals at the apparatus.

15. The method of claim 13, further comprising:
determining a modulation and coding scheme (MCS) value associated with a reference configuration for converting between the analog signals and the digital signals at the apparatus based on the information related to the channel measurement for the scheduled transmission with the apparatus; and
transmitting, to the apparatus, the MCS value associated with the reference configuration.

16. A device in a wireless network comprising:
a memory to store processor-executable instructions; and
at least one processor to execute the processor-executable instructions to cause the device to:
determine an operating configuration for converting between analog signals and digital signals at an apparatus; and
transmit, to the apparatus, information indicating the operating configuration,
wherein the operating configuration is associated with at least one of:
a bit resolution used by the apparatus when converting between the analog signals and the digital signals, or
a sampling rate used by the apparatus.

17. The device of claim 16, wherein the processor-executable instructions to cause the device to determine the operating configuration include processor-executable instructions to cause the device to:
select the operating configuration from a plurality of operating configurations for converting between the analog signals and the digital signals at the apparatus, each operating configuration of the plurality of operating configurations associated with at least one of:
a respective bit resolution used by the apparatus when converting between the analog signals and the digital signals, or
a respective sampling rate used by the apparatus.

18. The device of claim 16, wherein the processor-executable instructions when executed by the processor further cause the device to:
receive, from the apparatus, information related to channel measurement performed by the apparatus, the information related to the channel measurement being associated with the operating configuration; and
transmit control information scheduling a transmission with the apparatus, the control information allocating resources based on the information related to the channel measurement.

19. The device of claim 18, wherein the information related to the channel measurement includes information from one or more channel quality indicator (CQI) tables, the information from the one or more CQI tables including a CQI value, each CQI table of the one or more CQI tables being associated with at least one configuration for converting between the analog signals and the digital signals at the apparatus.

20. The device of claim 18, wherein the processor-executable instructions when executed by the processor further cause the device to:
determine a modulation and coding scheme (MCS) value associated with a reference configuration for converting between the analog signals and the digital signals at the apparatus based on the information related to the channel measurement for the scheduled transmission with the apparatus; and
transmit, to the apparatus, the MCS value associated with the reference configuration.
